(19) United States
(12) Patent Application Publication
(10) Pub. No.: US 2026/0077700 A1
(43) Pub. Date: Mar. 19, 2026

(54) STRAP BRACKET

(71) Applicant: FG Products, Inc., Rice Lake, WI (US)

(72) Inventors: Chad Nelson, Rice Lake, WI (US); Matthew Nelson, Cameron, WI (US)

(73) Assignee: FG Products, Inc., Rice Lake, WI (US)

(21) Appl. No.: 19/327,687

(22) Filed: Sep. 12, 2025

Related U.S. Application Data
(60) Provisional application No. 63/694,321, filed on Sep. 13, 2024.

(51) Int. Cl. B60P 3/20; B60P 7/14

(52) U.S. Cl. CPC B60P 3/205; B60P 7/14

(57) ABSTRACT

An improved accessory bracket for composite panels and the like is disclosed. In one embodiment, the accessory bracket comprises two flanges, each having two posts that protrude inwards into a panel in through holes. During assembly, the flanges are inserted into two through holes from opposite sides of the panel such that the posts (which are male and female) engage with each other. The male posts have an interior longitudinal channel adapted, e.g., to engage with a screw inserted from the outer face of the flange having a female post. The head of the screw rests against the face of the flange it is inserted into, and the threads pull the opposing flange towards it. When fully tightened, the flanges provide a compression force on a relatively wide area of the panel, providing a secure accessory attachment point on the panel.

### CROSS-REFERENCE TO RELATED APPLICATIONS

This application claims priority to U.S. provisional Ser. No. 63/694,321, filed on Sep. 13, 2024, the contents of which are incorporated herein by reference in their entirety.

### BACKGROUND

In the art of refrigerated transport, insulated bulkheads, panels, partitions, and the like can be used within a trailer to separate goods according to varying temperature needs (e.g., frozen, refrigerated, room temperature, etc.). Fiber Reinforced Plastics (FRP) composite panels, such as those made of ArmorLite™, can form the majority of an insulating panel, with supporting frames, seals, and other components added to complete an insulated panel. As many such panels are made to be handled during reconfiguration, loading, or unloading, handles are added to the panels to ease lifting and moving of the panels.

The core of typical FRP panels is designed for strength, when fused to a hard skin, for distributed loads. It has little to no local strength for point loads, however, such as holding screws without tearing. Accordingly, insulated panel handles have typically been constructed as shown in FIG. 1, where a handle assembly 100 includes two backing members 110, two strap loop retainers 112, four ¼″ bolts 114, four t-nuts 116, and a flexible strap 120 with sewn loops on each end. To attach a strap to an insulated panel, four 5/16″ holes are predrilled through the insulated panel at an appropriate spacing for strap 120 and strap loop retainers 112. One loop of strap 120 is slid onto a strap loop retainer 112, which is then positioned over a backing member 110, aligned with two of the predrilled holes. Two ¼″ bolts are inserted through the strap loop retainer, backing member, and predrilled holes. Two t-nuts 116 are threaded onto the ¼″ bolts on the backside of the panel and tightened until the assembly is secure against the insulated panel. The process is repeated for the opposite end of the strap to complete the assembly.

### SUMMARY OF ILLUSTRATIVE EMBODIMENTS

Several disadvantages are or can be present with the strap design of FIG. 1. Although the t-nuts 116 spread the load of the assembly somewhat, they are of limited size, and care must be taken not to deform/crush the composite panel when tightening the bolts. Further, the bolts 114 should not protrude past the back surface of panel, which would present a hazard to workers and could damage goods. Thus, the bolts must either 1) be of a specific length that, for a specific panel, engages sufficiently with threads of the t-nut without protruding through the nut, which generally will also require a deeper t-nut, or 2) be manually broken/cut off flush with or slightly below the level of the t-nut after assembly.

In accordance with various embodiments described herein, an accessory bracket is disclosed that generally overcomes the disadvantages present in the FIG. 1 design, while providing additional benefits such as better holding ability, the ability to provide a secure attachment point for a range of panel thicknesses with the same parts, and the ability to attach handles or other accessories to both sides of a panel at the same attachment point. Generally, the accessory brackets described herein comprise two flanges, each having two posts that protrude inwards into a composite panel in through holes. During assembly, the flanges are inserted into two through holes from opposite sides of the panel such that they engage with each other. In one embodiment, two male posts and two female posts are disposed on the flanges such that the posts mate inside the panel, e.g., slidingly engage. The male posts have an interior longitudinal channel adapted, e.g., to engage with a screw inserted from the outer face of the flange having a female post, through the female post central opening and into the end of the male post channel. The head of the screw rests against the face of the flange it is inserted into, and the threads pull the opposing flange towards it. When fully tightened, the flanges provide a compression force on a relatively wide area of the panel, equal on both sides of the panel. It is believed that this provides a superior holding ability while avoiding damage to the panel itself, and is easy to properly install.

The foregoing general description of the illustrative implementations and the following detailed description thereof are merely exemplary aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values or dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 illustrates, in perspective view, a prior art handle assembly for composite panels;

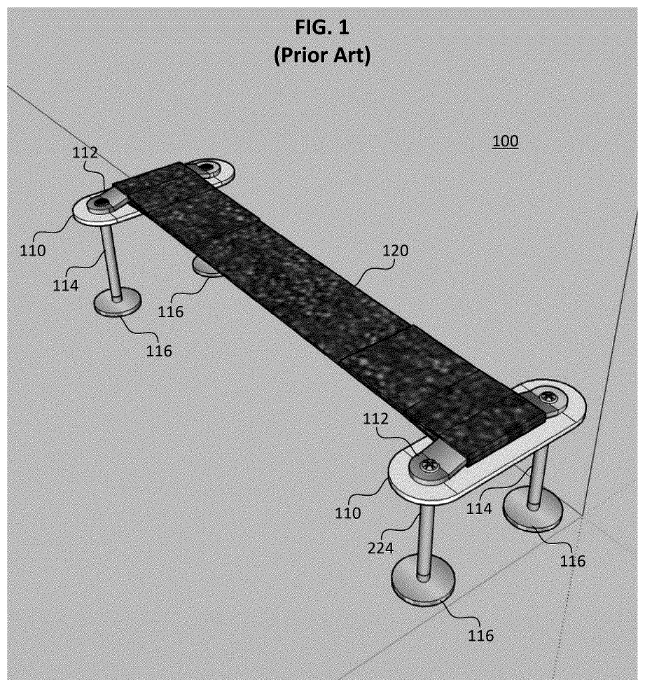

FIG. 2A shows, in perspective view, two flush mount flanges according to an embodiment;

FIG. 2B shows, in plan view, side elevation view, and end elevation view, the male flange of FIG. 2A;

FIG. 2C shows, in plan view, side elevation view, and end elevation view, the female flange of FIG. 2A;

FIG. 3 illustrates the flanges of FIG. 2A secured together to form an accessory bracket in a 2″ thick panel such as a composite panel;

FIG. 4 illustrates the flanges of FIG. 2A secured together to form an accessory bracket in a 2 ¾″ thick panel such as a composite panel;

FIG. 5 shows several panels such as composite panels deployed in a refrigerated trailer, with accessory handles attached using accessory bracket embodiments; and

FIG. 6 shows an alternative embodiment of complementary flush mount flanges that use a ratchet mechanism to secure themselves together through an opening in a panel.

### DETAILED DESCRIPTION OF ILLUSTRATIVE EMBODIMENTS

The description set forth below in connection with the appended drawings is intended to be a description of various, illustrative embodiments of the disclosed subject matter.

Specific features and functionalities are described in connection with each illustrative embodiment; however, it will be apparent to those skilled in the art that the disclosed embodiments may be practiced without each of those specific features and functionalities.

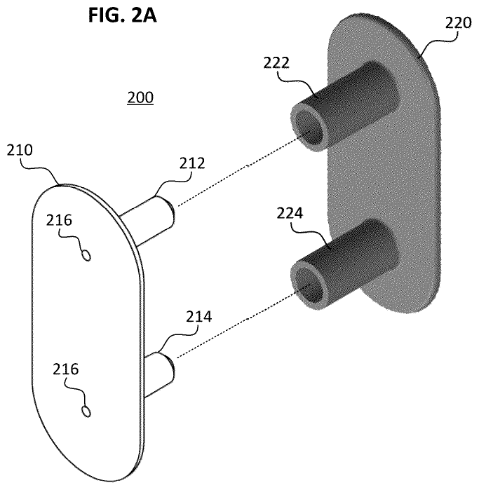

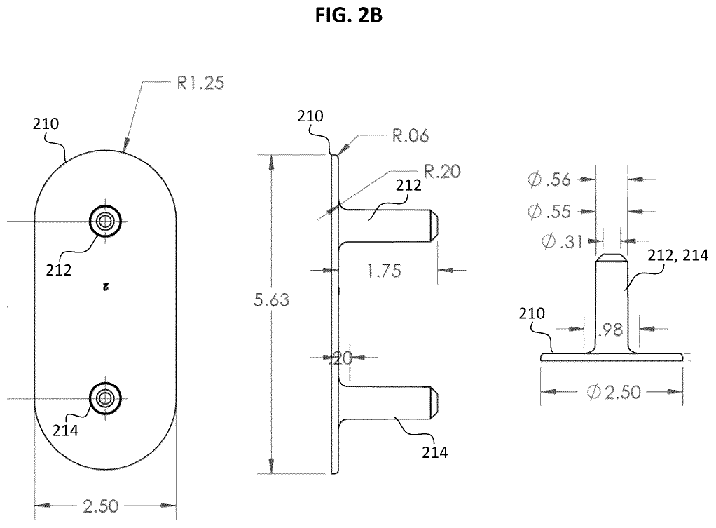

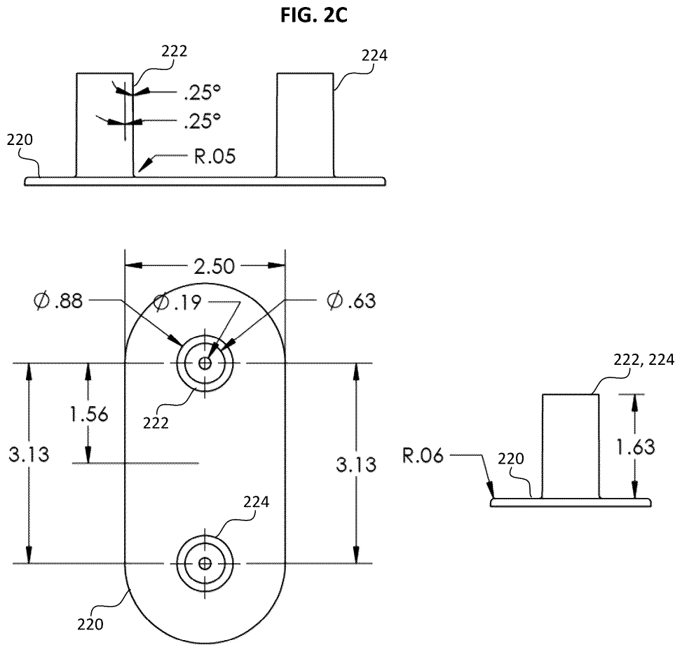

FIG. 2A illustrates, in perspective, an exploded view of an accessory bracket 200 comprising flush mount brackets 210 and 220. Brackets 210 and 220 are “flush mount” in that when properly assembled, the flange inner faces will substantially uniformly contact an outer surface of a panel, such that the flange protrudes above the panel only by its thickness (which, for example, is ⅛″). Brackets 210 and 220 are typically injection molded of a plastic such as polypropylene, but can be made of other materials and/or by other methods.

Male flange 210 has two posts 212 and 214 integrally formed with the inner flange face. The posts each have a longitudinal channel (not visible in this view) adapted to receive a fastener, such as a thread forming screw. In this embodiment, optional extensions 216 extend from the outer surface of each flange into the longitudinal channel to allow attachment of accessories to the male flange.

Female flange 220 also has two posts 222 and 224 integrally formed with its inner flange face. Posts 222 and 224 have an open end with a cylindrical shell section, adapted to receive/engage respectively with posts 212 and 214. Not visible in the outer face of flange 220 are a pair of starter holes aligned with the centers of posts 222 and 224. As will be illustrated below, thread forming screws driven into these starter holes are used to pull flanges 210 and 220 together to capture a composite panel and provide a secure attachment point for an accessory such as a strap, eyelet, or monitoring module.

FIG. 2B shows male flange 210 in plan view, side elevation view, and end elevation view. In one embodiment, the flange has semicircular ends, concentric with posts 212 and 214, with a radius of 1.25″. The flange ends are joined by a center section with straight sides, with posts 212 and 214 having a center-to-center spacing across this center section of 3 ⅛″. The flange thickness is ⅛″, with rounded edges on at least the inner face to avoid damage to a composite panel. The extended surface area of the flange spreads the compression load over a large area of a panel, allowing for better holding while reducing the chance of panel damage due to over compression.

Posts 212 and 214 are integrally formed with flange 210. A radiused transition from flange to post adds strength, and does not interfere with flush mounting as the holes in the panel are generally through-drilled at the larger dimension of the female posts of flange 220. Alternately, a strengthened transition area could be stepped, with an outer diameter equal to the outer diameter of the female posts. The remote end of posts 212 and 214 is preferably chamfered, as shown, to facilitate centering during blind engagement of the male and female posts within a center portion of a panel.

Post diameters are preferably selected for secure engagement with selected fasteners. In one embodiment, an outer post diameter of 9/16″ is selected, with a longitudinal circular channel having a 3/16″ diameter. In this embodiment, the longitudinal circular channel extends all the way through flange 210 to allow fasteners to be easily aligned with and screwed into posts from the frontside of the flange, as well as from the far ends of the posts.

FIG. 2C shows female flange 220 in plan view, side elevation view, and end elevation view. In one embodiment, flange 220 has the same face dimensions as flange 210.

Posts 222 and 224 are integrally formed with flange 210 as cylindrical shells. In this embodiment, each post has an outer diameter of ⅞″, and an inner diameter of ⅝″ to allow a 9/16″ male post to slidingly engage therein. In some embodiments, insertion of thread forming screws into a male post expands the diameter of the male post slightly, causing a tighter fit between the male and female posts. Either a male or a female post may have a tapered profile such that the posts fit more snugly with increased engagement. A 3/16″ diameter hole through the face of flange 210 is centered on each post to facilitate fastener positioning when securing the flanges to each other.

Preferably, flanges 210 and 220 are designed for use with a range of panel thicknesses. For instance, posts 212 and 214 may have a length of 1 ¾″, and posts 222 and 224 may have a length of 1 ⅝″. Thus, the thinnest panel that flanges 210 and 220 can secure to in this example would be slightly thicker than 1 ¾″, with 2″ providing ample room for compression. As it is preferable that the posts engage each other at least by some minimal amount, such as ¼″, the thickest panel that flanges 210 and 220 can secure to in this example would be about 3 ⅛″. A design range of thicknesses can thus be specified by a minimum and maximum thickness, a minimum or maximum thickness and a design ratio, or some other measure. With male and female posts of equal lengths, a design ratio can approach 2× the minimum panel thickness, with slightly lower ratios (e.g., 1.35×, 1.5× or 1.75×) providing preferred ranges of use.

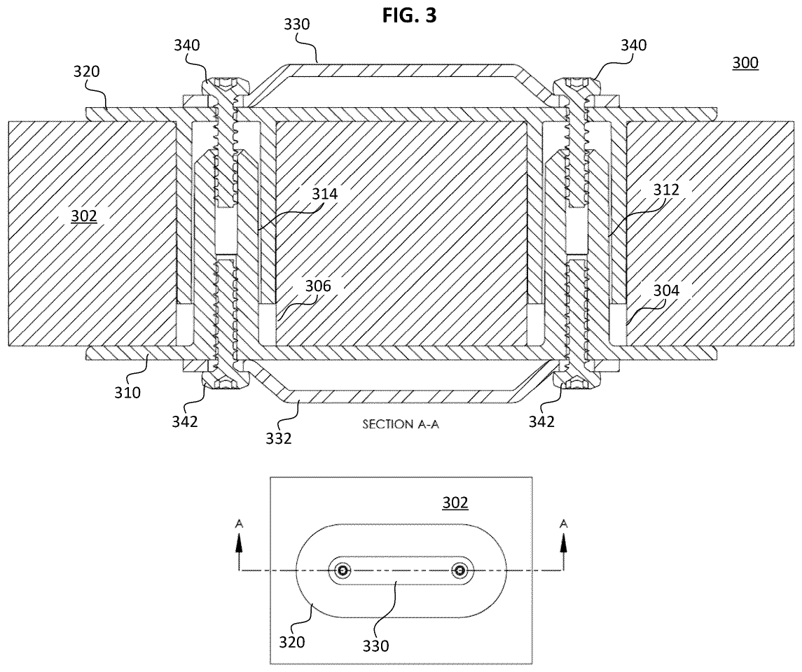

FIG. 3 illustrates, in cross section, an installed accessory bracket 300 according to an embodiment. Two 9/16″ holes 304, 306 are drilled through a 2″ thick panel 302 at a center-to-center spacing of 3 ⅛″. Panel 302 has a hole pattern comprised of two holes with a major dimension of 3 ⅛″. In an alternative embodiment, hole patterns are comprised of a plurality of holes with a major and minor dimension. Panel 302 may be an FRP panel, a different composite panel with a skinned core, a soft product such as a foam/vinyl fabric panel, or any other type of material suitable for inclusion in a panel. Panel rigidity may be largely inherent in the panel material, in a frame attached to the panel, or some combination of the two.

A female flange 320 is inserted into the holes from one side of the panel. A male flange 310 is inserted into the holes from the other side of the panel and pressed down for a flush fit with the panel by engaging the male posts of flange 310 with the female posts of flange 320. An aluminum strap loop retainer 330 having two holes near its ends at a 3 ⅛″ center-to-center spacing and a raised middle section is positioned in alignment with flange 320, and two thread forming screws 340 are inserted through the holes of retainer 330 and then driven into flange 320 and into the ends of male posts 312, 314, drawing flanges 310 and 320 together to capture and secure the assembly 300 in a compression fit to panel 302. Strap loop retainer 330 is also secured by fasteners 340 to flange 320 (when used to hold a strap (not shown) with sewn end loops, the strap end loop is slipped onto retainer 330 prior to attachment of at least one of screws 340). When used with a strap secured at both ends, a second similar assembly 300 is also attached to panel 320, in alignment with and spaced apart from the first assembly 300 an appropriate distance. Other accessories may similarly be attached using one or both fasteners 340. In other embodiments, an accessory feature could be, e.g., molded onto the outer surface of one or both of the flanges.

One advantage of accessory bracket 300 is an ability to readily attach accessories to either one of or both sides of panel 302. As shown in FIG. 3, a second strap loop retainer 332 is attached to flange 310 using two additional thread forming screws 342 driven into the longitudinal bores of posts 312, 314 from the flange sides of the posts. It may be preferable to attach retainer 332 to flange 310 prior to assembly with the panel.

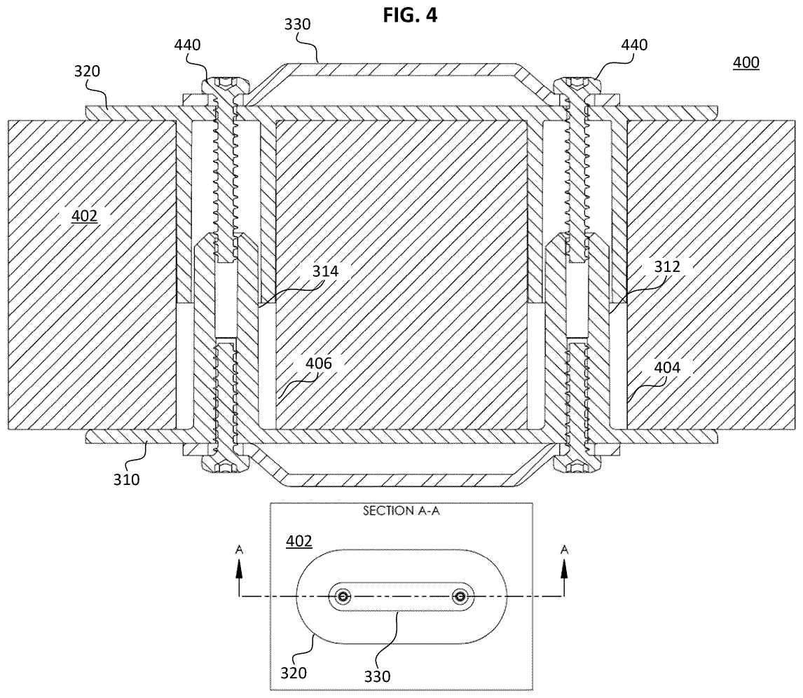

FIG. 4 illustrates, in cross section, the accessory bracket 300 installed in a different thickness of panel. Two 9/16″ holes 404, 406 are drilled through a 2 ¾″ thick panel 402 at a center-to-center spacing of 3 ⅛″. Female flange 320 is inserted into the holes from one side of the panel. Male flange 310 is inserted into the holes from the other side of the panel and pressed down for a flush fit with the panel by engaging the male posts of flange 310 with the female posts of flange 320 (note that the engagement of the posts is less than in FIG. 3 due to the thicker panel). Two longer thread forming screws 440 are inserted through the holes of retainer 330 and then driven into flange 320 and into the ends of male posts 312, 314, drawing flanges 310 and 320 together to capture and secure the assembly 300 in a compression fit to panel 402.

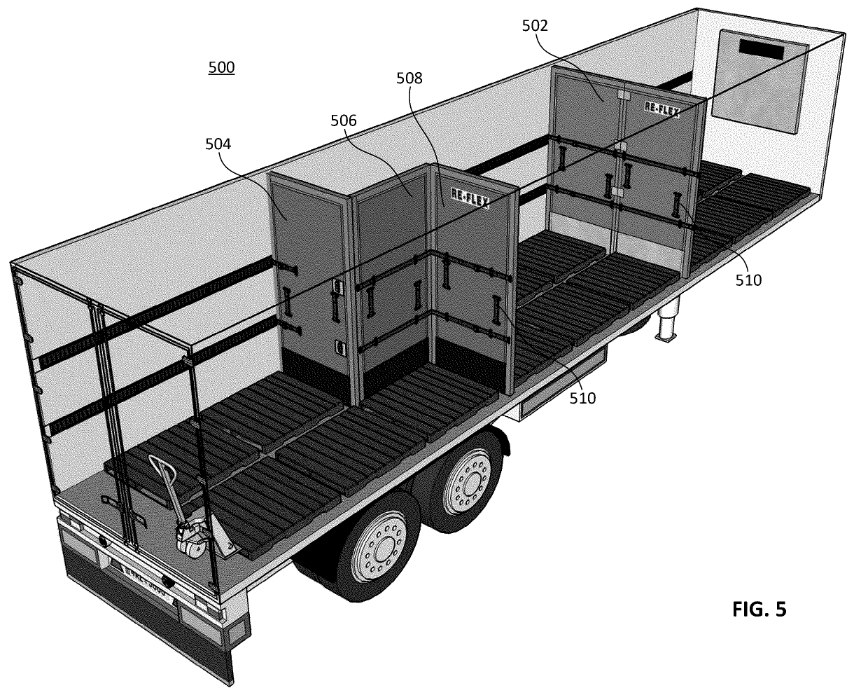

FIG. 5 shows a perspective view of a plurality of moveable panels and bulkheads 502, 504, 506, 508 deployed in a refrigerated trailer 500 to create different cooling zones therein. A plurality of straps (e.g., 510) attach to each of the panels and bulkheads to facilitate handling, using accessory brackets according to the disclosure.

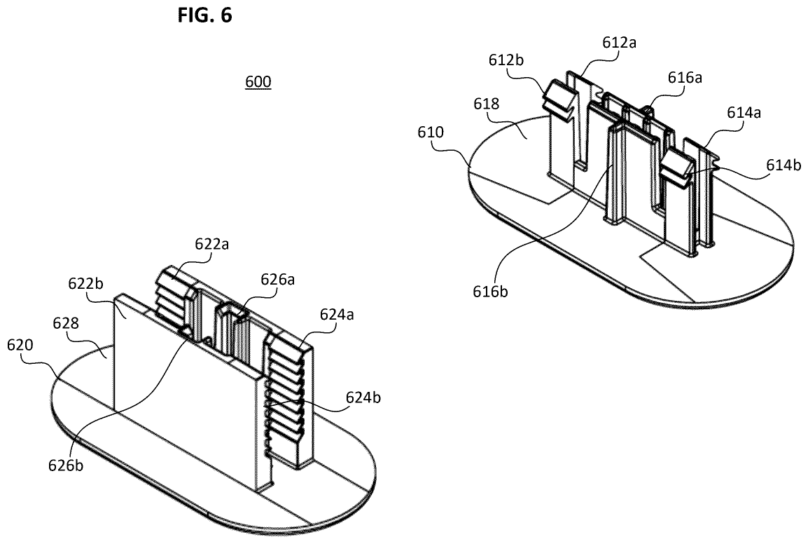

FIG. 6 illustrates, in perspective, two disassembled parts of an accessory bracket 600—flush mount brackets 610 and 620. Brackets 610 and 620 are “flush mount” in that when properly assembled, the flange (618 and 628, respectively) inner faces will substantially uniformly contact an outer surface of a panel, such that the flange protrudes above the panel only by its thickness (which, for example, is ⅛″). Brackets 610 and 620 are typically injection molded of a plastic such as polypropylene, but can be made of other materials and/or by other methods.

Male flange 610 has a number of features integrally formed with the flange 618 inner face, running just to either side of a central spine of the flange. These include a pair of left barbed tabs 612a, 612b, a pair of right barbed tabs 614a, 614b, and a pair of ribbed central tabs 616a, 616b. A longitudinal channel runs between the pairs of tabs, with a width adapted to receive a fastener, such as a thread forming screw. Note that the barbs on the barbed tabs face cant backwards toward the inner flange face and face away from the longitudinal channel.

Female flange 620 also has a number of features integrally formed with the flange 628 inner face, running just to either side of a central spine of the flange. These include a pair of left barbed ratchet tracks 622a, 622b, a pair of right barbed ratchet tracks 624a, 624b, and a pair of guide channels 626a, 626b. The features suffixed with “a” may be connected by webbing, as shown, as may the features suffixed with “b,” to provide strength and snug fit in a panel slot. A longitudinal channel running between the ratchet tracks and guide channels is spaced to receive the complementary features of the male flange 610, as will be described next. The guide channels and ratchet tracks face towards the longitudinal channel, and the barbs on the ratchet tracks cant backwards toward the inner flange face (and have a shape that will engage in complementary fashion with the barbs on the barbed tabs of male flange 610.

Instead of round mounting holes through a panel as in previous embodiments, accessory bracket 600 mounts to a panel through a rectangular opening sized to receive the features protruding from the inner face of flange 628. The rectangular opening may be cut on a CNC (Computer Numerical Control) machine or manually with a jig or guide frame and an appropriate cutting tool (router, saw, knife, etc., depending on panel composition and preference). Female bracket 620 is inserted through the hole in one side of the panel. Male bracket 610 is inserted through the hole in the opposite side of the panel and aligned such that the ribs on central tabs 616a, 616b engage and slide into respective guide channels 626b, 626a on bracket 620. Further engagement allows the barbed tabs 612a, 612b, 614a, 614b to deform inward enough to slide respectively between ratchet tracks 622b, 622a, 624b, 624a and “snap” into each groove in the tracks along the way, until the male bracket and female bracket flanges are firmly engaged with opposite sides of the panel. Due to the cant on the barbs and grooves of the ratchet tracks, the two bracket pieces can be engaged at various positions (and thus fit different sizes of panels), but firmly resist separation once engaged.

Although primary embodiments have been described in detail, other embodiments are possible. For instance, other fastener systems are possible—e.g., the inner posts could be threaded to accept bolts as fasteners, or push pins could be used as fasteners. Instead of one flange having male posts and the other having female posts, each flange could have one of each, allowing the flanges to be identical (but needing one fastener driven from each side of the partition to secure the assembly). Recesses can be formed in the flanges at the locations of fastener heads such that, when no accessory is mounted at that location, a fastener head can be at least partially recessed into the surface of the flange. Other modifications and embodiments will be apparent to those skilled in the art upon reading this disclosure.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration.

Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described, except where expressly stated or where the feature or function is incompatible with the additional embodiments. For example, where a given feature or function is expressly described in connection with one embodiment but not expressly mentioned in connection with an alternative embodiment, it should be understood that the inventor intended that that feature or function may be deployed, utilized or implemented in connection with the alternative embodiment unless the feature or function is incompatible with the alternative embodiment.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. An accessory bracket, the accessory bracket comprising:
a bracket through assembly for mounting to a panel through first and second through holes in the panel at a first center-to-center spacing, the bracket through assembly comprising first and second flush mount flanges,
each flange having disposed on one side thereof a pair of posts spaced at the first center-to-center spacing, adapted for insertion into the first and second through holes in the panel,
the pair of posts of the first flush mount flange adapted to engage with the pair of posts of the second flush mount flange such that, with the first flush mount flange placed against a first side of the panel with its posts inserted in the first and second through holes, and the second flush mount flange placed against a second side of the panel with its posts inserted in the first and second through holes, the respective posts of the first and second flush mount flanges engage over a range of possible thicknesses of the panel, and
two of the posts of the first and second flush mount flanges adapted to receive fasteners inserted through an opposite flange and post of the bracket through assembly to draw the first and second flush mount flanges together against the first and second sides of the panel.

2. The accessory bracket of claim 1, wherein the pair of posts of the first flush mount flange each comprise a cylindrical shell section with a first inner diameter, and the pair of posts of the second flush mount flange each comprise a cylindrical section with a first outer diameter that slidingly engages within the cylindrical shell section of a post of the first flush mount flange.

3. The accessory bracket of claim 2, wherein the first inner diameter is widest at the end of the post furthest from the flange of the first flush mount flange, and tapers toward the flange of the first flush mount flange.

4. The accessory bracket of claim 2, wherein each of the pair of posts of the second flush mount flange comprises a chamfered end with a maximum diameter equal to the first outer diameter.

5. The accessory bracket of claim 2, wherein each of the pair of posts of the second flush mount flange comprises a radiused joint at the end adjoining the flange of the second flush mount flange.

6. The accessory bracket of claim 2, wherein each of the pair of posts of the second flush mount flange comprises an interior longitudinal channel having a surface that fixedly engages with one of the fasteners inserted through the opposite flange.

7. The accessory bracket of claim 6, wherein the interior channel of each of the pair of posts of the second flush mount flange passes completely through that post and the abutting surface of the flange.

8. The accessory bracket of claim 7, wherein the fasteners comprise screws.

9. The accessory bracket of claim 8, further comprising an accessory attached to the first flush mount flange via one or more of the screws.

10. The accessory bracket of claim 8, wherein the bracket through assembly further comprises a strap loop retainer having first and second end sections with respective holes spaced apart from each other at the first center-to-center spacing, for securing the strap loop retainer to the first flush mount flange via the screws, and a middle section spaced apart from the first flush mount flange in an assembled condition.

11. The accessory bracket of claim 10, further comprising a strap having a first end supported by the middle section of the strap loop retainer in an assembled condition.

12. The accessory bracket of claim 11, wherein the through bracket assembly is a first through bracket assembly, the accessory bracket further comprising an identical second through bracket assembly mounted through third and fourth through holes in the panel, the strap having a second end supported by the middle section of the strap loop retainer of the second through bracket assembly in an assembled condition.

13. The accessory bracket of claim 12, wherein the strap is a first strap, and the strap loop retainers are first and second strap loop retainers, the accessory bracket further comprising a second strap and third and fourth strap loop retainers identical to the first and second strap loop retainers, the third and fourth strap loop retainers affixed respectively to the second flush mount flanges of the first and second through bracket assemblies via screws driven into the posts of the second flush mount flanges from the flange side of those posts, the middle sections of the third and fourth strap loop retainers supporting respective end sections of the second strap.

14. The accessory bracket of claim 8, wherein the range of thicknesses extend from a minimum thickness to a maximum thickness at least 135% of the minimum thickness.

15. The accessory bracket of claim 8, wherein the range of thicknesses extend from a minimum thickness to a maximum thickness at least 175% of the minimum thickness.

16. The accessory bracket of claim 1, wherein the pair of posts of the first flush mount flange are female posts, and the pair of posts of the second flush mount flange are male posts that slidingly engage with the pair of posts of the first flush mount flange.

17. The accessory bracket of claim 1, wherein each of the first and second flush mount flanges are identical, each flange having a first post of the pair that is female and a second post of the pair that is male.

18. The accessory bracket of claim 1, wherein each flange has a face with an outer edge defined by semicircular ends connected by straight sides.

19. The accessory bracket of claim 1, wherein the fasteners inserted through an opposite flange are inserted at locations having a recess such that a fully inserted fastener is at least partially recessed below an outer face of the flange.

20. The accessory bracket of claim 1, wherein at least one of the first and second flush mount flanges comprises an accessory integrally attached to a face of that flange.

21. An accessory bracket, the accessory bracket comprising:
a bracket through assembly for mounting to a panel through a through hole pattern in the panel, the through hole pattern having a major dimension and a minor dimension, the bracket through assembly comprising first and second flush mount flanges,
each flange having disposed on one side thereof a respective set of features adapted for insertion into the through hole pattern in the panel,
the set of features of the first flush mount flange adapted to engage with the set of features of the second flush mount flange such that, with the first flush mount flange placed against a first side of the panel with its set of features inserted in the through hole pattern, and the second flush mount flange placed against a second side of the panel with its set of features inserted in the through hole pattern, respective features of the set of features of the first flush mount flange engage with complementary features of the set of features of the second flush mount flange, over a range of possible thicknesses of the panel.

22. The accessory bracket of claim 21, wherein the features of the first and second flush mount features that engage over a range of possible thicknesses comprise complementary features that ratchet together as the first and second flush mount flanges are engaged, so as to resist separation of the first and second flush mount flanges.

23. The accessory bracket of claim 21, wherein the through hole pattern comprises first and second through holes in the panel at a first center-to-center spacing, and wherein the respective set of features of each flange comprises a pair of posts spaced at the first center-to-center spacing.
